(19) United States
(12) Patent Application Publication
(10) Pub. No.: US 2007/0243404 A1
(43) Pub. Date: Oct. 18, 2007

(54) Glass circuit board and manufacturing method thereof

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD., Taipei City (TW)

(21) Appl. No.: 11/785,022

(22) Filed: Apr. 13, 2007

(30) Foreign Application Priority Data
Apr. 14, 2006 (TW) 095113287

(51) Int. Cl. H01B 13/00; B32B 3/10; B32B 17/06; B41M 5/00

(52) U.S. Cl. 428/630; 428/137; 428/195.1; 428/433; 216/13; 216/17

(57) ABSTRACT

A manufacturing method of a glass circuit board includes the steps of providing a glass substrate; forming a metal layer on a surface of the glass substrate; forming a metal connecting layer on the metal layer; patterning the metal layer and the metal connecting layer to expose a part of the surface of the glass substrate; and forming an insulation layer with at least one opening on the patterned metal connecting layer and the exposed part of the surface. A glass circuit board is also disclosed, which includes a glass substrate, a patterned metal layer, a patterned metal connecting layer and an insulation layer. The glass substrate has a surface. The patterned metal layer is disposed on the surface of the glass substrate, and a part of the surface is exposed from the patterned metal layer. The patterned metal connecting layer is disposed on the patterned metal layer. The insulation layer has at least one opening, and is disposed on the patterned metal connecting layer and the exposed part of the surface of the glass substrate.

### CROSS REFERENCE TO RELATED APPLICATIONS

This Non-provisional application claims priority under 35 U.S.C. §119(a) on Patent Application No(s). 095113287 filed in Taiwan, Republic of China on Apr. 14, 2006, the entire contents of which are hereby incorporated by reference.

### BACKGROUND OF THE INVENTION

1. Field of Invention

The invention relates to a circuit substrate and a manufacturing method thereof, and, in particular, to a glass circuit board and a manufacturing method thereof.

2. Related Art

In today's information society, the market demand for multimedia applications is constantly expanding. Integrated circuit (IC) technology has been developed according to trends in digital devices, networks, local connections, and human interface technology. To satisfy the above-mentioned demands, electronic devices have to satisfy various requirements, such as the high-speed processing, the multi-functionality, integration, compactness, light weight, and low price. Thus, the integrated circuit package technology is approaching finer micro-structure and higher density. High density IC package technology, such as ball grid array (BGA) packages, chip-scale packages (CSP), flip chip packages and multi-chip modules (MCM), have been introduced. The IC package density represents the number of pins disposed in a unit area.

Because the integrated circuit has been made thin and light and the number of pins is increased even as the chip is reduced, the pad pitch between bonding pads corresponding to pins and the size of the bonding pad must be reduced. Correspondingly, the trace pitch between metal traces on a circuit board has to be reduced in order to accommodate the trend in miniaturized electronic products. Thus, the fine pitch technology using the trace pitch smaller than 50 microns has been developed. However, a precondition of the fine pitch technology is that a metal layer having the thickness of about 0.3 to 0.5 microns and good mechanical intensity has to be manufactured. In general, a vacuum sputtering process has to be utilized in order to obtain the required properties.

An organic resin material or a ceramic material serves as the material of the substrate in the conventional circuit board. A circuit board with a substrate made of the organic resin material cannot withstand the high temperatures of the vacuum sputtering process, and the coefficient of thermal expansion (CTE) of the resin material is very great. So, the metal trace formed on the substrate tends to crack. The ceramic substrate can withstand high temperatures. As in the circuit board having the substrate made of the organic resin material, however, the surface of the ceramic substrate has many voids. So, it is difficult to form thin and continuous metal layers or traces. Thus, it is difficult to apply fine pitch technology to the typical circuit board, and when the technology of the fine pitch smaller than 35 microns is utilized, the increased cost grows exponentially and the actual requirements cannot be satisfied.

As mentioned hereinabove, it is an important subject of the invention to provide a circuit substrate and a manufacturing method thereof, in which the fine pitch technology can be easily implemented without increasing the cost significantly.

### SUMMARY OF THE INVENTION

In view of the foregoing, the invention is to provide a glass circuit board and a manufacturing method thereof, which may be applied to precise pitch technology.

To achieve the above, the invention discloses a method of manufacturing a glass circuit board. The method includes the steps of: providing a glass substrate; forming a metal layer on a surface of the glass substrate; forming a metal connecting layer on the metal layer; patterning the metal layer and the metal connecting layer to expose a part of the surface of the glass substrate; and forming an insulating layer, with at least one opening, on the part of the surface of the glass substrate and the patterned metal connecting layer.

To achieve the above, the invention also discloses a glass circuit board, which includes a glass substrate, a patterned metal layer, a patterned metal connecting layer and an insulating layer. The glass substrate has a surface. The patterned metal layer is disposed on the surface of the glass substrate. A part of the surface of the glass substrate is exposed from the patterned metal layer. The patterned metal connecting layer is disposed on the patterned metal layer. The insulating layer has at least one opening and is disposed on the part of the surface of the glass substrate and the patterned metal connecting layer.

As mentioned hereinabove, a conventional printed circuit board having a substrate made of a resin material is replaced with a glass substrate in the glass circuit board and the manufacturing method thereof according to the invention. Thus, the glass circuit board can be easily applied to the precise pitch technology so as to reduce the size of the circuit board and thus achieve the lightness, thin-profile, and compactness requirements of the electronic product using the glass circuit board.

### BRIEF DESCRIPTION OF THE DRAWINGS

The invention will become more fully understood from the detailed description given herein below illustration only, and thus is not limitative of the present invention, and wherein:

FIG. 1 is a flow chart showing a method of manufacturing a glass circuit board according to an embodiment of the invention;

FIGS. 2A to 2F are one set of schematic illustrations showing the glass circuit board corresponding to the flow of FIG. 1; and

FIG. 3 is a schematic illustration showing the glass circuit board corresponding to the step S03 in the flow of FIG. 1.

### DETAILED DESCRIPTION OF THE INVENTION

The present invention will be apparent from the following detailed description, which proceeds with reference to the accompanying drawings, wherein the same references relate to the same elements.

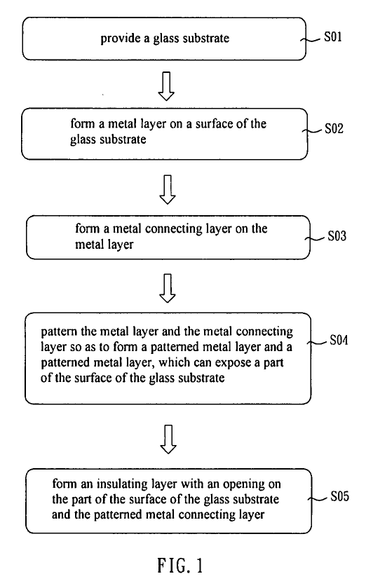

Referring to FIG. 1, a method of manufacturing a glass circuit board according to an embodiment of the invention includes steps S01 to S05.

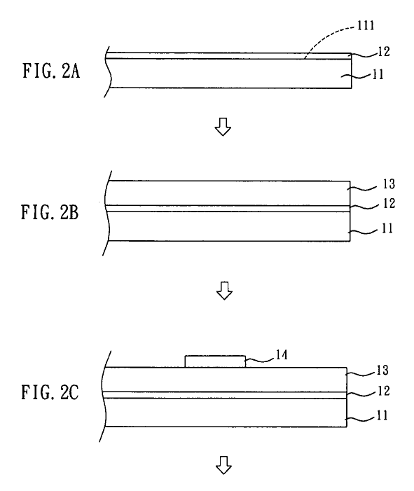

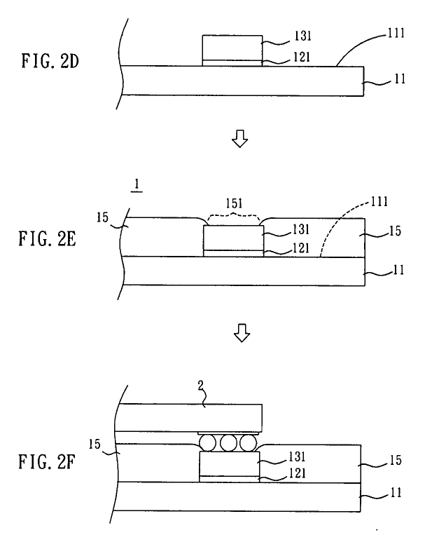

With reference to FIGS. 1 and 2A, in step S01, a glass substrate 11 is provided. Then, in step S02, a metal layer 12 is formed on a surface 111 of the glass substrate 11. The material of the metal layer 12 can be selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum. In this embodiment, the material of the metal layer 12 is copper.

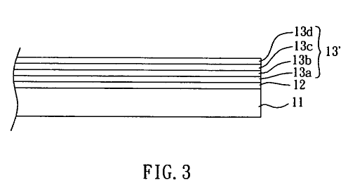

As shown in FIG. 2B, a metal connecting layer 13 is formed on the metal layer 12. The metal connecting layer 13 can be a single-layer structure or a multi-layer structure. The material of the metal connecting layer 13 may be, without limitation to, at least one of the group consisting of titanium, nickel, vanadium, copper, aluminum and gold. In this embodiment, the metal connecting layer 13 has a single-layer structure, and the material of the metal connecting layer 13 is copper, which is the same as that of the metal layer 12. Of course, as shown in FIG. 3, if the metal connecting layer 13′ has a multi-layer structure, it may include a titanium metal layer 13a, a nickel metal layer 13b, a vanadium metal layer 13c and a copper metal layer 13d in order.

With reference to FIGS. 2C and 2D, step S04 is to pattern the metal layer 12 and the metal connecting layer 13 so as to form a patterned metal layer 121 and a patterned metal layer 131, which can expose a part of the surface 111 of the glass substrate 11. In this embodiment, the step S04 for forming the patterned metal layer 121 and the patterned metal connecting layer 131 includes the following sub-steps. First, a resist layer is formed on the metal connecting layer 13 and patterned to form a patterned resist layer 14. Next, the metal layer 12 and the metal connecting layer 13 are etched using the patterned resist layer 14 as a mask to remove a part of the metal layer 12 and a part of the metal connecting layer 13. Accordingly, the patterned metal layer 121 and the patterned metal connecting layer 131 are formed.

In step S05, as shown in FIG. 2E, an insulating layer 15 with an opening 151 is formed on the part of the surface 111 of the glass substrate 11 and the patterned metal connecting layer 121. Then, a glass circuit board 1 can be obtained. In this embodiment, the patterned metal connecting layer 131 is exposed from the opening 151 of the insulating layer 15.

As shown in FIG. 2F, an electronic device 2 or a connecting terminal (not shown) may be disposed on the patterned metal connecting layer 131 by way of surface mount technology (SMT), wire bonding or flip-chip bonding in this embodiment. The electronic device 2 may be an active device or a passive device. In more specific, the electronic device 2 may be a resistor, a capacitor, an inductor, a transistor, a diode, a chip or a bare chip.

The method of manufacturing the glass circuit board according to the preferred embodiment of the invention has been described in detail. It is to be noted that the structure and the composition of the glass circuit board of the invention also have been described, so no repeated description for the glass circuit board will be made.

In summary, the conventional printed circuit board having a substrate made of a resin material is replaced with a glass substrate in the glass circuit board and the manufacturing method thereof according to the invention. Compared with the conventional resin substrate and the ceramic substrate, the glass substrate of the invention can withstand high temperature and has the fewer surface voids. Thus, the glass circuit board can be easily applied to the precise pitch technology in order to reduce the size of the circuit board and thus satisfy the lightness, thin-profile, and compactness requirements of electronic product using the disclosed glass circuit board.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of manufacturing a glass circuit board, the method comprising the steps of:
providing a glass substrate;
forming a metal layer on a surface of the glass substrate;
forming a metal connecting layer on the metal layer;
patterning the metal layer and the metal connecting layer to expose a part of the surface of the glass substrate; and
forming an insulating layer, with at least one opening, on the part of the surface of the glass substrate and the patterned metal connecting layer.

2. The method according to claim 1, wherein the patterned metal connecting layer is exposed from the opening of the insulating layer.

3. The method according to claim 1, wherein a material of the metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum.

4. The method according to claim 1, wherein a material of the metal connecting layer is selected from at least one of the group consisting of titanium, nickel, vanadium, copper, aluminum and gold.

5. The method according to claim 1, wherein the step of patterning the metal layer and the metal connecting layer comprises:
forming a resist layer on the metal connecting layer and patterning the resist layer to form a patterned resist layer; and
etching the metal connecting layer and the metal layer with the patterned resist layer serving as a mask to remove a part of the metal layer and a part of the metal connecting layer, to form the patterned metal layer and the patterned metal connecting layer and to thus expose with the part of the surface of the glass substrate.

6. The method according to claim 1, further comprising the step of:
disposing an electronic device or a connecting terminal on the metal connecting layer by way of surface mount technology, wire bonding or flip-chip bonding.

7. The method according to claim 6, wherein the electronic device is an active device or a passive device.

8. The method according to claim 6, wherein the electronic device is a resistor, a capacitor, an inductor, a transistor, a diode, a chip or a bare chip.

9. A glass circuit board, comprising:
a glass substrate having a surface;
a patterned metal layer disposed on the surface of the glass substrate, wherein a part of the surface of the glass substrate is exposed from the patterned metal layer;
a patterned metal connecting layer disposed on the patterned metal layer; and
an insulating layer, which is disposed on the part of the surface of the glass substrate and the patterned metal connecting layer, and has at least one opening.

10. The glass circuit board according to claim 9, wherein the patterned metal connecting layer is exposed from the opening of the insulating layer.

11. The glass circuit board according to claim 9, wherein a material of the metal layer is selected from at least one of the group consisting of titanium, a titanium-tungsten alloy, aluminum, a chromium-nickel alloy, copper, a nickel-vanadium alloy, a chromium-copper alloy, a nickel-titanium alloy and molybdenum.

12. The glass circuit board according to claim 9, wherein a material of the metal connecting layer is selected from at least one of the group consisting of titanium, nickel, vanadium, copper, aluminum and gold.

13. The glass circuit board according to claim 9, further comprising an electronic device or a connecting terminal electrically connected with the patterned metal connecting layer.

14. The glass circuit board according to claim 13, wherein the electronic device or the connecting terminal is disposed on the patterned metal connecting layer by way of surface mount technology, wire bonding or flip-chip bonding.

15. The glass circuit board according to claim 13, wherein the electronic device is an active device or a passive device.

16. The glass circuit board according to claim 13, wherein the electronic device is a resistor, a capacitor, an inductor, a transistor, a diode, a chip or a bare chip.
